(19) United States
(12) Patent Application Publication
(10) Pub. No.: US 2001/0045739 A1
(43) Pub. Date: Nov. 29, 2001

(54) METHOD AND DEVICE FOR AUTHORIZING PHOTOCOPIES

(75) Inventor: DEE R. WOOLLEY JR., LAYTON, UT (US)

Correspondence Address: LLOYD W. SADLER OR DANIEL P. MCCARTHY, PARSONS BEHLE & LATIMER, 201 SOUTH MAIN STREET, SUITE 1800, SALT LAKE CITY, UT, 84111-2218, US

(73) Assignee: woolley

(21) Appl. No.: 09/394,966

(22) Filed: Sep. 10, 1999

(51) Int. Cl. B42D 15/00

(52) U.S. Cl. 283/67; 380/54; 283/902; 705/57

(57) ABSTRACT

A method and device for authorizing or “legalizing” photocopies is disclosed. This method permits users to photocopy published copyrighted materials then “legalize” the copy by acquiring and fixing to the photocopy a label that is specifically designed to provide easy verification that the label is an original. The preferred label has a colored background, which photocopies to black. This invention provides a simple straightforward solution to the problem of illegal photocopying of copyrighted documents.

### BACKGROUND OF THE INVENTION

1. Field of the Invention

This invention relates to photocopy authorization methods and devices. More specifically, this invention relates to photocopy authorization methods and devices which permit a user to copy a copyrighted document and then to “legalize” the document by ordering and affixing a particular type of label to the copied document.

2. Description of the Related Art

The sale and control of copyrighted documents has posed a substantial problem to publishers, in particular music, recipe, and article publishers. Typically, such publishers either rely on the user not to photocopy and distribute or provide permission to copy a specified number of copies for an additional charge. Generally, prior techniques do not permit a user of copyrighted materials to “authorize” or “legalize” a copy after making the copy. Similarly, the use of a specific labeling device, which is not easily copyable, that provides a high degree of flexibility, has, to the best knowledge of the inventor, not been proposed or suggested previously.

For general background material, the reader is directed to the following United States Patent documents, each of which is hereby incorporated by reference for the material contained therein.

U.S. Pat. No. 5,436,974 describes a method of encoding serial numbers indicating the “confidentiality” or “proprietary information” on printed documents.

U.S. Pat. No. 5,521,815 describes a uniform, centralized system for converting all existing systems into one unique, universal system, which allows for tracking those titles for articles of value.

U.S. Pat. No. 5,621,200 describes an electronic verification machine for determining the authenticity and integrity of various types of documents, such as lottery tickets.

U.S. Pat. No. 5,629,981 describes a closed loop, information management and security system, which provides a secure, end-to-end fully automated solution for controlling access, transmission, manipulation and auditability of high value information.

U.S. Pat. No. 5,671,282 describes a document processing system in which a server subsystem stores information corresponding to a document containing human readable and machine-readable information.

U.S. Pat. No. 5,679,945 describes an intelligent card reader that is provided to replace existing magnetic stripe readers.

U.S. Pat. No. 5,682,421 describes an automated dispatch system that permits field technicians to interface with a central computer via conventional telephone systems that utilize DTMF protocols.

U.S. Pat. No. 5,753,899 describes a cash-alternative transaction processing system and associated methods based on the use of smart cards.

U.S. Pat. No. 5,818,019 describes a system for the determination of authenticity and integrity of various types of documents.

### SUMMARY OF THE INVENTION

It is desirable to provide a method and device, which permits user to “legalize” photocopied, published materials, while providing a simple means for identifying such “legalized” copies.

Therefore, it is the general object of this invention to provide a method and device for “legalizing” photocopied copyrighted materials.

It is a further object of this invention to provide a method, which makes use of a specific label design for the identification of “legalized” copies.

It is another object of this invention to provide a method, which makes use of a label design that is not easily copyable.

It is a still further object of this invention to provide a method for the labeling of photocopied copyrighted materials that is easy for the user to employ.

Another object of this invention is to provide a method for “legalizing” photocopies of copyrighted materials, that provides important ordering and installing information.

A still further object of this invention is to provide a method for “legalizing” photocopies of copyrighted materials, that permits the user to fix a “distinctive” legalization label to the copyrighted materials.

These and other objects of this invention will be readily apparent to those of ordinary skill in the art upon review of the following detailed description, drawings and claims.

### BRIEF DESCRIPTION OF THE DRAWINGS

FIG. 1 is a flow diagram of the preferred method of this invention.

FIG. 2 is a drawing of the preferred label used with the method of this invention.

FIG. 3 shows the preferred label affixed to a document.

### DETAILED DESCRIPTION OF THE INVENTION

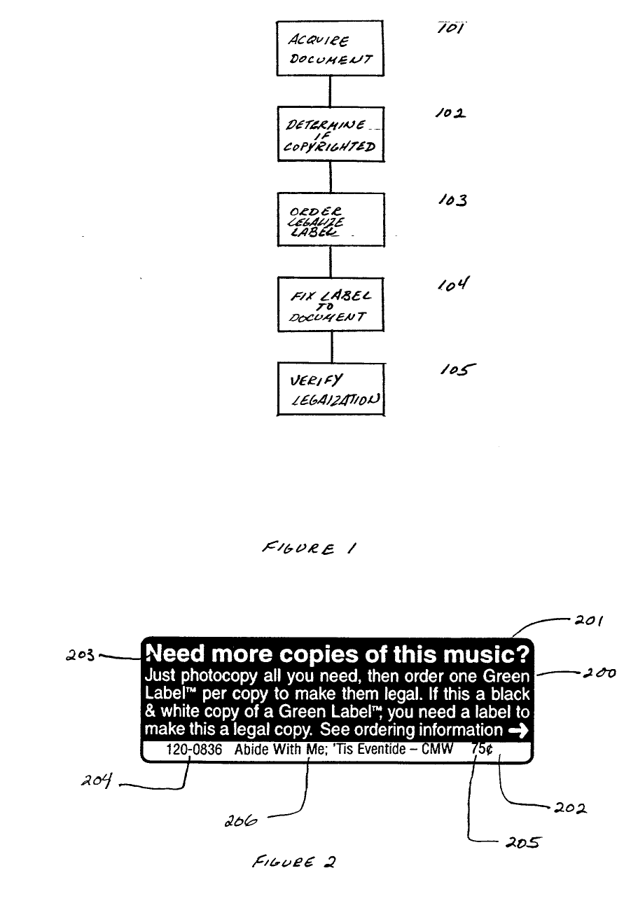

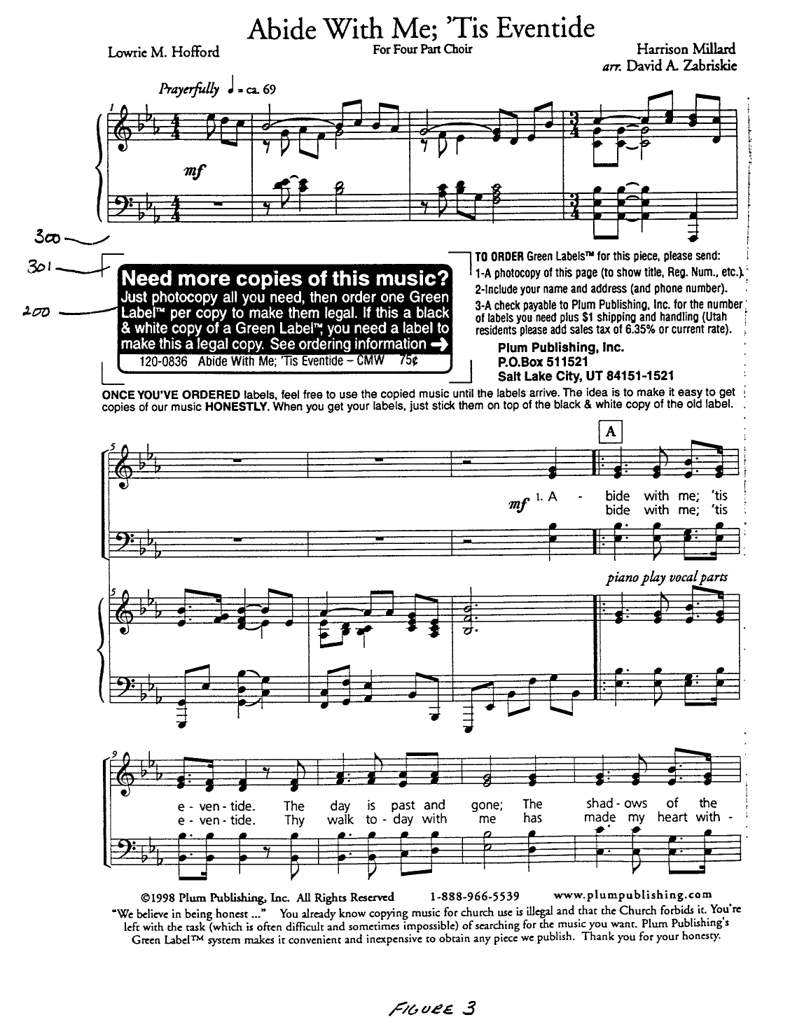

This invention is a method and device for the identification, labeling and “legalization” of photocopied copyrightable materials. The preferred embodiment of the invention includes the specific steps designated in FIG. 1 and the specific label device shown in FIG. 2, however, contemplated alternative embodiments of the invention, may not require each specified step and may employ label devices with a variety of additional or substituted elements.

FIG. 1 shows the preferred steps of this invention. In the preferred embodiment of this invention, a user acquires 101 a document. Typically, the document is acquired by copying through standard photocopying means. Once the user acquires a copy of the document, a determination 102 is made as to whether the document is copyrighted. Generally, this determination 102 is made by an examination of the document for the standard copyright notice. If it is determined that the document is copyrighted, then a “legalization” label is ordered 103. When the “legalization” label is received it is fixed 104 to the document. Preferably, the document is provided with a designated location for placement of the “legalization” label. At this point, the document can be verified 105 as “legalized.” In the preferred mode of this invention, “legalization” is verified by determining that a label has been fixed to the document and that the label is an original rather than a copy. Verification, in the preferred embodiment, is accomplished by verifying the color of the label, although alternative means for verification, such as textured labels, relatively thick labels, multi-colored labels having a message that is hidden when copied, and the like are also envisioned as being within the scope of the invention.

FIG. 2 shows the preferred label used with the method of this invention. This label 200 functions by virtue of its green background 201 color, which when copied appears to be black. Text 203 is provided to give instructions to the user. Typically and preferably, the text is presented in an easy to copy color. A description block 202 provides space for describing the document for fixation of the label 200. Within the description block 202 is an identification element 204 for matching the appropriate label 200 to the appropriate document 300. Also, provided within the description block 202 is the document title 206 and a price indicator 205. In the preferred, best embodiment of this invention, the price indicator 205 is printed in the same color as the background 201, thereby providing an easy method of identifying the price associated with the “legal” copies of each document. This preferred label 200 uses white letters 203 on a green background 201, although alternative colors and additional colors can be used without departing from the concept of this invention. This label 200 can also, alternatively, be substantially different in dimension as required for the particular document to be “legalized.”

FIG. 3 shows the preferred label fixed to a typical document as accomplished by this invention. This figure shows a typical document 300, in this case a copyrighted music score, having a label 200 fixed to the label block 301. While this figure shows a music score as the document 300, this invention works equally well with other documents, including but not limited to articles and article reprints, photographs, prints, posters and works of art.

The described embodiment, and its alternatives, are to be considered in all respects only as illustrative and not as restrictive. Although the preferred embodiment includes specific steps and the preferred label employs has certain instructions and is composed of certain material, and has a preferred shape and colors, this invention is not limited thereto. Rather, the scope of this invention is indicated by the appended claims instead of the foregoing description. All changes, which come within the meaning and range of equivalency of the claims, are to be embraced as being within their scope.

I claim:

1. A method for authorizing photocopies, comprising:
(A) acquiring a document;
(B) determining whether said acquired document is copyrighted;
(C) ordering a “legalization” label, if said acquired document is copyrighted, wherein said “legalization” label has an identification element;
(D) fixing said “legalization” label to said acquired document; and
(E) verifying that said acquired document is “legalized.”

2. A method for authorizing photocopies, as recited in claim 1, wherein said acquiring document further comprises copying a document.

3. A method for authorizing photocopies, as recited in claim 1, wherein said determining whether said acquired document is copyrighted, further comprises finding a copyright notice on said acquired document.

4. A method for authorizing photocopies, as recited in claim 1, wherein fixing said “legalization” label further comprises adhesively attaching said “legalization” label to a label block on said acquired document.

5. A method for authorizing photocopies, as recited in claim 1, wherein said verifying step further comprises identifying the color of said “legalization” label.

6. A method for authorizing photocopies, as recited in claim 1, wherein said verifying step further comprises identifying the texture of said “legalization” label.

7. A method for authorizing photocopies, as recited in claim 1, wherein said verifying step further comprises identifying the thickness of said “legalization” label.

8. A photocopy authorization device, comprising:
(A) a first side, having a background, a description block, a price indicator printed in the same color as said background, and instruction text; and
(B) a second side, having an adhesive surface for fixing said device to a document.

9. A photocopy authorization device, as recited in claim 8, further comprising a textured surface.

10. A photocopy authorization device, as recited in claim 8, wherein said background of said first side is a color selected to be opaque after photocopying.
